(19) United States
(12) Patent Application Publication
(10) Pub. No.: US 2012/0319987 A1
(43) Pub. Date: Dec. 20, 2012

(54) SYSTEM AND METHOD FOR CALIBRATING AN INPUT DEVICE

(75) Inventor: Alfred WOO, Santa Clara, CA (US)

(73) Assignee: SYNAPTICS INCORPORATED, Santa Clara, CA (US)

(21) Appl. No.: 13/161,261

(22) Filed: Jun. 15, 2011

(51) Int. Cl. G06F 3/044; G06F 3/041

(52) U.S. Cl. 345/174; 345/178

(57) ABSTRACT

The embodiments described herein provide devices, systems and methods that facilitate improved performance in an input device. The input device, for example, may include an input surface configured to be touched by input objects, a haptic mechanism configured to provide a haptic effect to the input surface, a force sensor configured to sense force applied to the input surface, and a processing system communicatively coupled to the haptic mechanism and the force sensor. The processing system may be configured to actuate the haptic mechanism to apply a first force to the input surface, determine a representation of the first force using the force sensor, and determine a calibration parameter for at least one of the haptic mechanism and force sensor based at least in part upon the representation of the first force.

### FIELD OF THE INVENTION

This invention generally relates to electronic devices.

### BACKGROUND OF THE INVENTION

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

Over time the input device may become subject to dirt, debris, spills, drops and may be exposed to elements (i.e., high temperatures, low temperatures, moisture, etc) which may degrade a user's interaction with the input device.

Thus, methods, systems and devices for addressing the above are desirable. Other desirable features and characteristics will become apparent from the subsequent detailed description and the appended claims, taken in conjunction with the accompanying drawings and the foregoing technical field and background.

### BRIEF SUMMARY OF THE INVENTION

In one exemplary embodiment an input device is provided. The input device may include an input surface configured to be touched by input objects, a haptic mechanism configured to provide a haptic effect to the input surface, a force sensor configured to sense force applied to the input surface, and a processing system communicatively coupled to the haptic mechanism and the force sensor. The processing system may be configured to actuate the haptic mechanism to apply a first force to the input surface, determine a representation of the first force using the force sensor, and determine a calibration parameter for at least one of the haptic mechanism and force sensor based at least in part upon the representation of the first force.

In another exemplary embodiment a processing system for an input device having an input surface configured to be touched by input objects, a haptic mechanism configured to haptically affect the input surface and a force sensor configured to determine force applied to the input surface is provided. The processing system may include sensing circuitry configured to sense input near or on the input surface, a haptic module configured to control an actuation of the haptic mechanism, a force sensing module configured to control the force sensor and a calibration module. The calibration module may be configured to receive information from the force sensing module related to a first force applied to the input surface by the haptic mechanism and determine a calibration parameter for at least one of the haptic module and force sensing module based at least in part upon the received information.

In yet another exemplary embodiment a method for determining a calibration parameter for an input device having an input surface configured to be touched by input objects, a haptic mechanism configured to provide a haptic effect to the input surface and a force sensor configured to determine a force applied to the input surface, is provided. The method may include actuating the haptic mechanism to apply a first force to the input surface, determine a representation of the first force using the force sensor, and determining the calibration parameter for at least one of the haptic mechanism and the force sensor based at least in part upon the representation of the first force.

### BRIEF DESCRIPTION OF DRAWINGS

Exemplary embodiments will hereinafter be described in conjunction with the appended drawings, where like designations denote like elements, and:

FIG. 1 illustrates an exemplary input device 100 in accordance with an embodiment.

FIG. 2 illustrates an exemplary method 200 for calibrating an input device in accordance with an embodiment.

FIG. 3 is a block diagram of an exemplary input device 300, in accordance with an embodiment.

### DETAILED DESCRIPTION OF THE DRAWINGS

The following detailed description is merely exemplary in nature and is not intended to limit the embodiments or the application and uses of the embodiments. Furthermore, there is no intention to be bound by any expressed or implied theory presented in the preceding technical field, background, brief summary or the following detailed description.

Various embodiments provide input devices and methods that facilitate improved usability. As discussed below, the input device uses a haptic mechanism and a force sensor to self calibrate such that the amount of haptic feedback a user feels and the amount of force a user has to apply to the input device to trigger a particular action remains relatively consistent over the life of the input device.

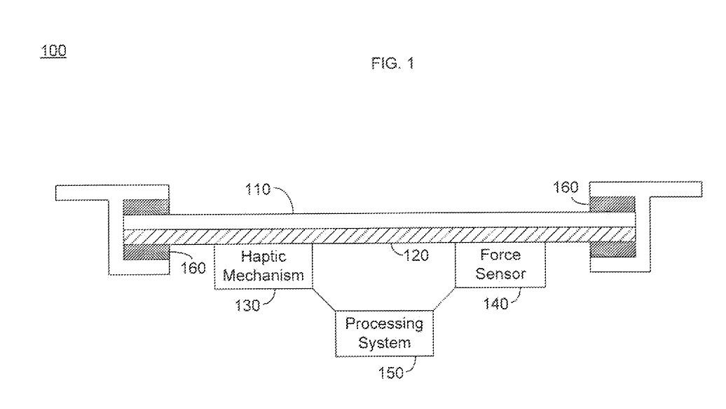

Turning now to the figures, FIG. 1 illustrates an exemplary input device 100. The input device 100 includes an input surface 110, at least one sensing electrode 120, a haptic mechanism 130 for providing a haptic effect to the input surface 110 and a force sensor 140 for sensing a force applied to the input surface 110 and a processing system 150. In one embodiment the touch surface may be supported by a deflection mechanism 160. The deflection mechanism 160 can be, for example, a compliant seal which allows the input surface 110 to deflect while offering some protection for the underlying at least one sensing electrode 120, haptic mechanism 130 and force sensor 140. However, over time the compliancy of a compliant seal could change due to exposure to various elements (sun, water, cold or hot temperatures), dirt, dust, spills, drops, cuts or other abuse. In other embodiments, the deflection mechanism 160 may not provide a seal. When the input surface does not include a compliant seal, dirt or other debris (screws, food, spills, etc) could get beneath the input surface. The degradation of the compliant seal and/or debris which gets below the input surface 110 may affect a force measured by the force sensor 140 and/or an amount of haptic feedback applied to the input surface 110 by the haptic mechanism 130. In other embodiments, the behavior of the input device 100 may change over time due to the “settling” of tolerances and parts from after manufacturing. This may require a user to apply more or less force to trigger a certain action or to feel more or less haptic feedback. Accordingly, the processing system 150 is configured to calibrate the input device 100 to compensate for variations in mechanical resistance caused by degradation of the compliant seal and/or debris, as discussed in further detail below.

The at least one sensing electrode 120 could be part of any type of sensing system capable of detecting a touch or multiple touches by input objects on or near the input surface 110. For example, the sensing circuitry could use resistive, surface acoustic wave, capacitive, surface capacitance, projected capacitance, mutual capacitance, self-capacitance, infrared, optical imaging, dispersive signal or acoustic pulse recognition technology or any combination thereof for sensing input on or near the input surface 110.

The haptic mechanism 130 could be any type of haptic device capable of applying a haptic effect to the input surface 110. For example, the haptic mechanism 130 could use electroactive polymers or a piezoelectric element to provide the haptic effect. In other embodiments, the haptic mechanism could use electrostatic surface actuation or a vibratory motor with an offset mass to produce the haptic effect. In one embodiment, for example, the processing system 150 sends a signal to the haptic mechanism 130 which applies a haptic effect to the input surface based upon the signal. A representation of the force applied to the input surface 110 by the haptic effect is measured and used to determine a calibration parameter for the input device, as discussed in further detail below.

The force sensor 140 could be any type of force sensor capable of determining a representation of a force applied to the input surface 110, such as strain gauges and capacitive force sensor. Measurements of this variable capacitance may be determined and used to determine a representation of the force applied to the input surface 110. The processing system 150, discussed in further detail below, uses the change of capacitance measurements for calibration of the input device 100, as discussed in further detail below. In another embodiment multiple force sensors may be positioned proximate to the input surface. For example, in one embodiment, four force sensors 140 may be used to measure the force at each corner of the input surface 110. In this embodiment, a calibration parameter may be determined for each of the force sensors 140, as discussed in further detail below.

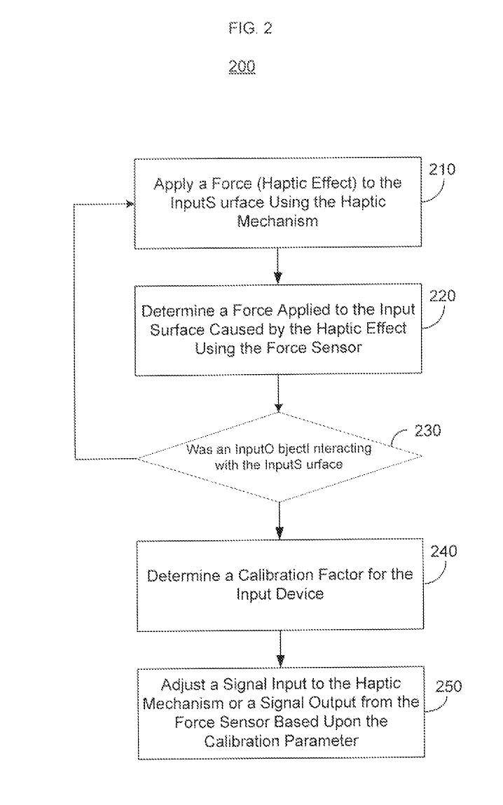

FIG. 2 illustrates an exemplary method 200 for calibrating an input device in accordance with an embodiment. The processing system 150 begins the calibration process by signaling the haptic mechanism 130 to apply a haptic effect to the input surface 110. (Step 210). The predetermined haptic effect can be of any duration, any frequency and any pattern. As discussed above, the processing system 150 may send a signal to the haptic mechanism at a predetermined amplitude, shape and duration. In one embodiment, for example, the predetermined haptic effect may be a single pulse at a predetermined amplitude and length. In other embodiments, the haptic effect may be a signal sweep across multiple frequencies. In still other embodiments, multiple actuation waveforms, multiple pulses or multiple signal sweeps, may be implemented. In other embodiments, a predetermined haptic effect may be applied to the input surface 110 which is selected from a group of predetermined haptic effects. In this embodiment, the processing system 150 may cycle through the group of predetermined haptic effects, applying a different haptic effect during each cycle of the calibration process.

In one embodiment, for example, the calibration process may occur when the input device 100 is first powered on or initiated. In other embodiments, the calibration process may be a user initiated event. In still other embodiments, the calibration process may occur periodically or at random intervals, or any combination there of.

The processing system 150 then determines a representation of the force sensed by the force sensor 140 caused by the haptic effect. (Step 220). As discussed above, the haptic effect may be applied to the input surface 110 over a predetermined duration. Accordingly, in some embodiments, multiple force measurements may be sampled over the predetermined duration.

The processing system 150 may then validate the data. (Step 230). When an input object touches the input surface 110, the force sensor 140 will output a representation of that force. Accordingly, if an input object is touching the input surface 110 during the calibration process, the force measured by the force sensor 140 will be increased based upon the force of the input object. As such, for calibration purposes, the force measured by the force sensor when an input object is touching the input surface 110 would be corrupted. As discussed above, the input device 100 includes at least one sensing electrode 120 for sensing input objects on or near the input surface 110. Accordingly, the processing system 150 can validate the representation of the force measurement by determining if an input object was touching the input surface 110 during the calibration process. In one embodiment, for example, if the processing system 150 determines that an input object was touching the input surface 110 during the calibration process, the processing system 150 may restart the calibration process. In other embodiments, if the processing system 150 determines that an input object was touching the input surface 110 during the calibration process, the processing system 150 may simply end the calibration process. In still other embodiments, the processing system 150 may monitor the at least one sensing electrode 120 to determine when the input object is no longer touching the input surface 110 before restarting the calibration process. Likewise, in another embodiment, the processing system 150 may monitor the at least one sensing electrode 120 before initiating the calibration process (i.e., before Step 210) during any iteration of the calibration process. In still other embodiments, the processing system 150, before initiating the calibration process (i.e., before Step 210) and during any iteration of the calibration process, may determine if an input object is touching the input surface 110 and prompt a user to remove the input object from the input surface 110 before proceeding with the calibration process.

If the processing system 150 determines that no input object was touching the input surface during Steps 210 and 220, the processing system 150 then determines a calibration parameter for at least one of the force sensor 140 and haptic mechanism 130. (Step 240). In one embodiment, for example, the processing system 150 compares the representation of the force measured by the force sensor 140 with an expected force. Based upon the difference between the expected force and the measured force, the processing system can determine a calibration parameter for at least one of the force sensor 140 and haptic mechanism 130.

The expected force may be determined, for example, based upon a bench test. For example, a force measurement can be taken on a “baseline” device using a predetermined haptic effect. The force measurement taken from the “baseline” device could then be stored in a memory (not shown) in communication with the processing system 150. Accordingly, by applying the same haptic effect to the input surface 110 (i.e., Step 210) and taking measurement of the representation of the force applied to the input surface 110 by the force sensor 140 (i.e., Step 220), a comparison can be made between the measured force detected by the input device 100 and the expected force.

In one embodiment, for example, the expected force for a given haptic effect may be based upon a test device which does not have a compliant seal. As discussed above, the input device 100 may optionally include a compliant seal. Accordingly, in this embodiment, the input device 100 can be calibrated such that force sensor 140 and/or haptic mechanism 130 perform as if the input device did not include compliant seal, as discussed in further detail below.

In another embodiment, for example, the expected force for a given haptic effect may be based upon a test device which does have a compliant seal. Accordingly, in this embodiment, the input device 100 can be calibrated such that force sensor 140 and/or haptic mechanism 130 are compensated for any possible degradation to the compliant seal due to age, dirt, sun exposure or any other factor which could cause the compliant seal to gain or loose compliancy relative to the compliant seal on the test device.

In one embodiment, for example, the calibration parameter may be used to adjust a force measured by the force sensor. (Step 250). As discussed above, the compliant seal can become less compliant over time, which could cause the force sensor 140 to measure a lower force relative to the test device when the same input force is applied to both devices. In other instances the compliant seal may become more complaint over time, which could cause the force sensor to measure a greater force than the test device when the same input force is applied to both devices. In other embodiments where the input device 100 does not include the compliant seal, dirt or other debris which gets below the input surface may cause the force sensor may measure a greater or lesser amount of force than the test device given the same input force. As discussed above, when an input object touches the input surface 110, the processing system 150 may use the representation of the force applied to the input surface 110 to trigger different events. Accordingly, the calibration parameter may be used such that the force required to trigger a given event by an input object remains substantially consistent over the life of the input device regardless of any degradation to the compliant seal and/or dirt or other debris which would have otherwise affected the representation of the force measured by the force sensor.

The calibration parameter may be based upon, for example, a difference between an expected force and the force measured by the input device 100. The calibration parameter can be added to the measured force, subtracted from the measured force, multiplied or divided to the measured force, or may scale the measured force in any other fashion. In one embodiment, the processing system 150 may adjust the force measured by the force sensor 140. In another embodiment, another circuit may modify the representation of the force measured by the force sensor 140 before the processing system 150 receives the measurement. For example, a signal from the force sensor 140 may pass through a multiplier circuit (not shown) which multiples the signal based upon the calibration parameter, before the signal is received by the processing system 150.

In another embodiment, the calibration parameter may be based upon an average difference between an expected force and a series of measured forces. In still other embodiments, the calibration parameter may be based upon a median difference between an expected force and a series of measured forces. The calibration parameter may also be based upon a weighted average, where the force measured from certain haptic effects is weighted more heavily in the calibration parameter calculation.

As discussed above, the input device 100 may have multiple force sensors 140 positioned proximate to different areas of the input surface 110. In this embodiment, the processing system 150 may determine a separate calibration parameter for each force sensor 140. Accordingly, in this embodiment, the processing system 150 can compensate for differences of the degradation of different areas of the complaint seal or for compensating, for example, for debris concentrated under one area of the input surface 110.

In another embodiment, the processing system 150 may use the calibration parameter to adjust a drive signal (i.e., an input) to the haptic mechanism 130. (Step 250). As discussed above, the compliant seal may degrade over time due to various causes, or, if the input device has no compliant seal, dirt or other debris may get beneath the input surface which could affect the amount of haptic feedback perceived by the user. Accordingly, in this embodiment the processing system may adjust an input to the haptic mechanism such that the perceived level of haptic feedback by the user remains relatively consistent over the life of the input device 100 regardless of the compliancy of the compliant seal and/or any amount of dirt or other debris which affects the input surface 110.

As discussed above, the calibration parameter may be based upon a difference between an expected force and the force measured by the input device 100. The calibration parameter may modify the signal sent to the haptic mechanism 130 in any manner (for example, addition, subtraction, multiplication, division, etc.). In one embodiment, the processing system 150 may adjust the signal sent to the haptic mechanism 130 based upon the calibration parameter. In another embodiment, another circuit may modify the signal sent to the haptic mechanism 130. For example, a signal from the processing system 150 may pass through a multiplier circuit (not shown) which multiples the signal based upon the calibration parameter, before the signal is received by the haptic mechanism 130.

As discussed above, the processing system 150 may direct the haptic mechanism 130 to apply a haptic effect to the input surface 110. In one embodiment, the haptic effect could be a signal sweep across multiple frequencies. In another embodiment, the calibration process may apply a different haptic effect having different characteristics, such as frequency, shape, duration and/or amplitude. In some instances, condition of the compliant seal or the dirt or other debris affecting the input surface may affect the input surface 110 differently for the various haptic effects. In these embodiments, the processing system 150 may determine a calibration parameter for each haptic effect. Thereafter, whenever the processing system 150 directs the haptic mechanism 130 to apply a haptic effect to the input surface 110, the processing system 150 could use a calibration parameter corresponding to the haptic effect to adjust the input signal to the haptic mechanism 130. In other embodiments, the processing system 150 may consider an average calibration parameter, a median calibration parameter, a weighted average calibration parameter or any other combination of multiple calibration parameter measurements when applying a haptic effect.

In one embodiment, the processing system 150 may also determine if a determined calibration parameter exceeds a predetermined maximum calibration parameter. For example, if the determined calibration would otherwise increase the signal sent to the haptic mechanism or the force measured by the force sensor 140 by a factor of ten, the processing system 150 could decide that there is a fault in the input device 100 and may issue an error code. When the input device 100 includes multiple force sensors 140 or multiple haptic mechanisms 130, the processing system 150 may be able to diagnose if one of the force sensors 140 or haptic mechanisms 130 is experiencing an error based upon a calibration parameter associated with the particular force sensors 140 or haptic mechanisms 130.

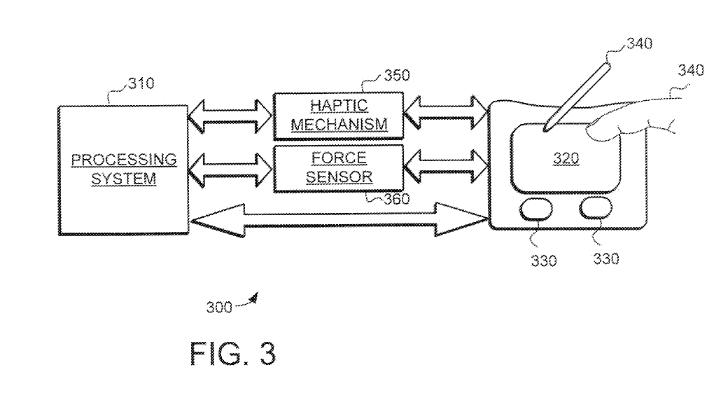

FIG. 3 is a block diagram of another exemplary input device 300, in accordance with an embodiment. The input device 300 may be configured to provide input to an electronic system (not shown). As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 300 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 300 can be implemented as a physical part of the electronic system, or can be physically separate from the electronic system. As appropriate, the input device 300 may communicate with parts of the electronic system using any one or more of the following: buses, networks, and other wired or wireless interconnections. Examples include I²C, SPI, PS/2, Universal Serial Bus (USB), Bluetooth, RF, and IRDA.

In FIG. 3, the input device 300 is shown as a proximity sensor device (also often referred to as a “touchpad” or a “touch sensor device”) configured to sense input provided by one or more input objects 340 in a sensing region 320. Example input objects include fingers and styli, as shown in FIG. 3.

Sensing region 320 encompasses any space above, around, in and/or near the input device 300 in which the input device 300 is able to detect user input (e.g., user input provided by one or more input objects 340). The sizes, shapes, and locations of particular sensing regions may vary widely from embodiment to embodiment. In some embodiments, the sensing region 320 extends from a surface of the input device 300 in one or more directions into space until signal-to-noise ratios prevent sufficiently accurate object detection. The distance to which this sensing region 320 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 300, contact with an input surface (e.g. a touch surface) of the input device 300, contact with an input surface of the input device 300 coupled with some amount of applied force or pressure, and/or a combination thereof. In various embodiments, input surfaces may be provided by surfaces of casings within which the sensing electrodes reside, by face sheets applied over the sensing electrodes or any casings, etc. In some embodiments, the sensing region 320 has a rectangular shape when projected onto an input surface of the input device 300.

The input device 300 may utilize any combination of sensor components and capacitive sensing technologies to detect user input in the sensing region 320. For example, the input device 300 comprises one or more sensing elements for capacitively detecting user input.

Some implementations are configured to provide images that span one, two, or three dimensions in space. Some implementations are configured to provide projections of input along particular axes or planes.

In some capacitive implementations of the input device 300, voltage or current is applied to create an electric field. Nearby input objects cause changes in the electric field, and produce detectable changes in capacitive coupling that may be detected as changes in voltage, current, or the like.

Some capacitive implementations utilize arrays or other regular or irregular patterns of capacitive sensing elements to create electric fields. In some capacitive implementations, separate sensing elements may be ohmically shorted together to form larger sensing electrodes. Some capacitive implementations utilize resistive sheets, which may be uniformly resistive.

Some capacitive implementations utilize “self capacitance” (or “absolute capacitance”) sensing methods based on changes in the capacitive coupling between sensing electrodes and an input object. In various embodiments, an input object near the sensing electrodes alters the electric field near the sensing electrodes, thus changing the measured capacitive coupling. In one implementation, an absolute capacitance sensing method operates by modulating sensing electrodes with respect to a reference voltage (e.g. system ground), and by detecting the capacitive coupling between the sensing electrodes and input objects.

Some capacitive implementations utilize “mutual capacitance” (or “transcapacitance”) sensing methods based on changes in the capacitive coupling between sensing electrodes. In various embodiments, an input object near the sensing electrodes alters the electric field between the sensing electrodes, thus changing the measured capacitive coupling. In one implementation, a transcapacitive sensing method operates by detecting the capacitive coupling between one or more transmitting electrodes and one or more receiving electrodes. Transmitting sensing electrodes may be modulated relative to a reference voltage (e.g., system ground) to facilitate transmission, and receiving sensing electrodes may be held substantially constant relative to the reference voltage to facilitate receipt. Sensing electrodes may be dedicated transmitters or receivers, or may be configured to both transmit and receive.

In FIG. 3, a processing system (or “processor”) 310 is shown as part of the input device 300. The processing system 310 is configured to operate the hardware of the input device 300 to detect input in the sensing region 320. The processing system 310 comprises parts of or all of one or more integrated circuits (ICs) and/or other circuitry components; in some embodiments, the processing system 310 also comprises electronically-readable instructions, such as firmware code, software code, and/or the like. In some embodiments, components composing the processing system 310 are located together, such as near sensing element(s) of the input device 300. In other embodiments, components of processing system 310 are physically separate with one or more components close to sensing element(s) of input device 300, and one or more components elsewhere. For example, the input device 300 may be a peripheral coupled to a desktop computer, and the processing system 310 may comprise software configured to run on a central processing unit of the desktop computer and one or more ICs (perhaps with associated firmware) separate from the central processing unit. As another example, the input device 300 may be physically integrated in a phone, and the processing system 310 may comprise circuits and firmware that are part of a main processor of the phone. In some embodiments, the processing system 310 is dedicated to implementing the input device 300. In other embodiments, the processing system 310 also performs other functions, such as operating display screens, driving haptic actuators, etc.

The processing system 310 may be implemented as a set of modules that handle different functions of the processing system 310. Each module may comprise circuitry that is a part of the processing system 310, firmware, software, or a combination thereof. In various embodiments, different combinations of modules may be used. Example modules include hardware operation modules for operating hardware such as sensing electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In accordance with some embodiments, a haptic module is configured to control an actuation of a haptic mechanism 350 configured to haptically affect an input surface of the input device 300. Likewise, a force sensing module is configured to control a force sensor 360 configured to determine a force applied to an input surface of the input device 300. Further, a calibration module is configured to receive information from the force sensing module related to a force applied to the input surface by a haptic mechanism 350 and is further configured to determine a calibration parameter for at least one of the haptic module and force sensing module based at least in part on the received information. The processing system 310 may also include sensing circuitry configured to sense input near or on the input surface using sensing electrodes in the sensing region 320.

In some embodiments, the processing system 310 responds to user input (or lack of user input) in the sensing region 320 directly by causing one or more actions. Example actions include changing operation modes, as well as GUI actions such as cursor movement, selection, menu navigation, and other functions. In some embodiments, the processing system 310 provides information about the input (or lack of input) to some part of the electronic system (e.g. to a central processing system of the electronic system that is separate from the processing system 310, if such a separate central processing system exists). In some embodiments, some part of the electronic system processes information received from the processing system 310 to act on user input, such as to facilitate a full range of actions, including mode changing actions and GUI actions.

For example, in some embodiments, the processing system 310 operates the sensing element(s) of the input device 300 to produce electrical signals indicative of input (or lack of input) in the sensing region 320. The processing system 310 may perform any appropriate amount of processing on the electrical signals in producing the information provided to the electronic system. For example, the processing system 310 may digitize analog electrical signals obtained from the sensing electrodes. As another example, the processing system 310 may perform filtering or other signal conditioning. As yet another example, the processing system 310 may subtract or otherwise account for a baseline, such that the information reflects a difference between the electrical signals and the baseline. As yet further examples, the processing system 310 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes position in a plane. Exemplary “three-dimensional” positional information includes position in space and position and magnitude of a velocity in a plane. Further examples include other representations of spatial information. Historical data regarding one or more types of positional information may also be determined and/or stored, including, for example, historical data that tracks position, motion, or instantaneous velocity over time. Likewise, a “position estimate” as used herein is intended to broadly encompass any estimate of object location regardless of format. For example, some embodiments may represent a position estimates as two dimensional “images” of object location. Other embodiments may use centroids of object location.

“Force estimate” as used herein is intended to broadly encompass information about force(s) regardless of format. Force estimates may be in any appropriate form and of any appropriate level of complexity. For example, some embodiments determine an estimate of a single resulting force regardless of the number of forces that combine to produce the resultant force (e.g. forces applied by one or more objects apply forces to an input surface). Some embodiments determine an estimate for the force applied by each object, when multiple objects simultaneously apply forces to the surface. As another example, a force estimate may be of any number of bits of resolution. That is, the force estimate may be a single bit, indicating whether or not an applied force (or resultant force) is beyond a force threshold; or, the force estimate may be of multiple bits, and represent force to a finer resolution. As a further example, a force estimate may indicate relative or absolute force measurements. As yet further examples, some embodiments combine force estimates to provide a map or an “image” of the force applied by the object(s) to the input surface. Historical data of force estimates may also be determined and/or stored.

The positional information and force estimates are both types of object information that may be used to facilitate a full range of interface inputs, including use of the proximity sensor device as a pointing device for selection, cursor control, scrolling, and other functions.

In some embodiments, the input device 300 is implemented with additional input components that are operated by the processing system 310 or by some other processing system. These additional input components may provide redundant functionality for input in the sensing region 320, or some other functionality. FIG. 3 shows buttons 330 near the sensing region 320 that can be used to facilitate selection of items using the input device 300. Other types of additional input components include sliders, balls, wheels, switches, and the like. Conversely, in some embodiments, the input device 300 may be implemented with no other input components.

In some embodiments, the input device 300 comprises a touch screen interface, and the sensing region 320 overlaps at least part of an active area of a display screen. For example, the input device 300 may comprise substantially transparent sensing electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 300 and the display screen may share physical elements. For example, some embodiments may utilize some of the same electrical components for displaying and sensing. As another example, the display screen may be operated in part or in total by the processing system 310.

It should be understood that while many embodiments of the invention are described in the context of a fully functioning apparatus, the mechanisms of the present invention are capable of being distributed as a program product (e.g., software) in a variety of forms. For example, the mechanisms of the present invention may be implemented and distributed as a software program on information bearing media that are readable by electronic processors (e.g., non-transitory computer-readable and/or recordable/writable information bearing media readable by the processing system 310). Additionally, the embodiments of the present invention apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

The description and examples set forth herein were presented in order to best explain embodiments of the invention and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

What is claimed is:

1. An input device, comprising:
an input surface configured to be touched by input objects;
a haptic mechanism configured to provide a haptic effect to the input surface;
a force sensor configured to sense force applied to the input surface; and
a processing system communicatively coupled to the haptic mechanism and the force sensor, the processing system configured to:
actuate the haptic mechanism to apply a first force to the input surface,
determine a representation of the first force using the force sensor, and
determine a calibration parameter for at least one of the haptic mechanism and the force sensor based at least in part upon the representation of the first force.

2. The input device of claim 1, wherein the processing system is configured to determine the calibration parameter by:
determining a difference between the representation of the first force and an expected force; and
determining the calibration parameter for at least one of the haptic mechanism and the force sensor based at least in part upon the difference.

3. The input device of claim 2, wherein the processing system is further configured to adjust a drive signal input to the haptic mechanism based upon the calibration parameter.

4. The input device of claim 2, wherein the processing system is further configured to adjust a force measured by the force sensor based upon the calibration parameter.

5. The input device of claim 1, wherein the input surface further comprises capacitive sensor electrodes for sensing input on or near the input surface.

6. The input device of claim 5 wherein the processing system is further configured to determine an absence of the input objects when actuating the haptic mechanism.

7. The input device of claim 1, wherein the processing system is configured to actuate the haptic mechanism in different ways by providing a plurality of different actuation waveforms to the haptic mechanism.

8. The input device of claim 1, wherein the processing system is further configured to:
actuate the haptic mechanism to apply a second force to the input surface;
determine a representation of the second force using the force sensor; and
determine the calibration parameter based on the representation of the first force and the representation of the second force.

9. A processing system for an input device having an input surface configured to be touched by input objects, a haptic mechanism configured to haptically affect the input surface and a force sensor configured to determine force applied to the input surface, the processing system comprising:
sensing circuitry configured to sense input near or on the input surface;
a haptic module configured to control an actuation of the haptic mechanism;
a force sensing module configured to control the force sensor; and
a calibration module configured to:
receive information from the force sensing module related to a first force applied to the input surface by the haptic mechanism, and
determine a calibration parameter for at least one of the haptic module and the force sensing module based at least in part upon the received information.

10. The processing system of claim 9, wherein the calibration module is configured to determine the calibration parameter by:
determining a difference between a force applied to the input surface and an expected force based at least in part upon the received information; and
determining the calibration parameter for at least one of the haptic module and the force sensing module based at least in part upon the determined difference.

11. The processing system of claim 10, wherein the processing system is further configured to adjust a drive signal for the haptic module based upon the calibration parameter.

12. The processing system of claim 10, wherein the processing system is further configured to adjust a force determined by the force sensing module based upon the calibration parameter.

13. The processing system of claim 9, wherein the haptic module is further configured to control the haptic mechanism to provide a plurality of unique haptic effects.

14. The processing system of claim 9, wherein the calibration module is further configured to:
receive information from the force sensing module related to a second force applied to the input surface by the haptic mechanism; and
determine the calibration parameter for at least one of the haptic module and the force sensing module based at least in part upon the received information related to the first force and the received information related to the second force.

15. The processing system of claim 9, wherein the calibration module is further configured to validate the received information if the sensing circuitry sensed no input on or near the input surface when the haptic mechanism was actuated.

16. A method for determining a calibration parameter for an input device having an input surface configured to be touched by input objects, a haptic mechanism configured to provide a haptic effect to the input surface and a force sensor configured to determine a force applied to the input surface, the method comprising:
actuating the haptic mechanism to apply a first force to the input surface;
determine a representation of the first force using the force sensor; and
determining the calibration parameter for at least one of the haptic mechanism and the force sensor based at least in part upon the representation of the first force.

17. The method of claim 16, wherein determining the calibration parameter further comprises:
determining a difference between the representation of the first force and an expected force; and
determining the calibration parameter for at least one of the haptic mechanism and the force sensor based at least in part upon the difference.

18. The method of claim 16, further comprising adjusting at least one of a drive signal to the haptic mechanism based upon the calibration parameter and a force measurement by the force sensor based upon the calibration parameter.

19. The method of claim 16, further comprising:
actuating the haptic mechanism to apply a second force to the input surface;
determine a representation of the second force using the force sensor; and
determining the calibration parameter for at least one of the haptic mechanism and the force sensor based at least in part upon the representation of the first force and the representation of the second force.

20. The method of claim 16, further comprising determining an absence of input objects touching the input surface.
